(19) United States
(12) Patent Application Publication
(10) Pub. No.: US 2023/0144238 A1
(43) Pub. Date: May 11, 2023

(54) SYSTEM AND METHOD FOR SCHEDULING MACHINE LEARNING JOBS

(71) Applicant: SAMSUNG SDS CO., LTD., Seoul (KR)

(72) Inventors: Joon Yi KIM, Seoul (KR); Byung Yong SUNG, Seoul (KR); Jun Cheol LEE, Seoul (KR); Chang Ju LEE, Seoul (KR)

(21) Appl. No.: 17/979,110

(22) Filed: Nov. 2, 2022

(30) Foreign Application Priority Data
Nov. 9, 2021 (KR) 10-2021-0153402

(51) Int. Cl. G06F 9/50

(52) U.S. Cl. CPC G06F 9/5038; G06F 2209/5019; G06F 2209/503

(57) ABSTRACT

A system for scheduling machine learning jobs includes a user interface provision unit to transmit, to a user terminal, data for forming an input interface to receive job information including information indicative of a checkpoint file of a model to be executed and require resource information, a resource management unit to manage a job queue, wherein each item of the job queue includes the job information and annotation including an expected execution time, complement for an item in which the expected execution time is not recorded in the annotation by receiving the expected execution time from an execution time expectation unit, and execute job scheduling using the job information of each item of the job queue, and an execution time expectation unit to calculate memory usage necessary for executing the model using information of the checkpoint file and determine the expected execution time of the model, using the memory usage.

### CROSS-REFERENCE TO RELATED APPLICATION AND CLAIM OF PRIORITY

This application claims the benefit under 35 USC § 119 Korean Patent Application No. 10-2021-0153402, filed on Nov. 9, 2021 in the Korean Intellectual Property Office, the entire disclosure of which is incorporated herein by reference for all purposes.

### BACKGROUND

### 1. Technical Field

The present disclosure relates to a system and method for scheduling machine learning jobs, and more particularly, to a system and method that calculate the expected time required for machine learning jobs and allocates cloud resources for each machine learning job requested to execute using the calculating results.

### 2. Description of the Related Art

In order to execute machine learning jobs, a large number of computational resources have to be invested. Accordingly, a machine learning job is generally performed by allocating resources through a cloud system consisting of multiple computational resources. Therefore, there is a clear need for scheduling for determining the execution order of each machine learning job.

For efficient scheduling, it is necessary to predict the expected execution time of each machine learning job. Conventionally, a statistical model based on a floating point operation (FLOP) of the model execution or a model where the execution time was machine-learned according to the FLOP was used to predict the execution time of the machine learning job. However, since the execution time of the machine learning job is determined by various factors other than the FLOP, it is difficult to trust prediction of the expected time of execution based only on the FLOP of the model execution. Therefore, the scheduling for determining the execution order of each machine learning job has not been also efficiently performed.

In a paper entitled “Predicting the Computational Cost of Deep Learning Models”, Daniel Justus et al. provided a method for machine-learning a model that outputs computational costs for learning a deep learning model using several layer features and hardware features. However, in addition to the layer features and hardware features, a variety of factors affect the expected execution time of machine learning jobs; therefore, despite the description of Daniel Justus's paper, there is still a need to accurately expect the execution time of machine learning jobs.

In addition, in a system requested to execute machine learning jobs, there is a need (request) for providing a system that receives the minimum amount of information while obtaining the exact expected execution time using the received information in order to increase user convenience, and handles even automatic scheduling based on the expected execution time.

### SUMMARY

Aspects of the present disclosure provide a system and method for scheduling machine learning jobs that automatically determine an expected execution time using an analysis result of the machine learning jobs, and schedule the machine learning jobs using the determined expected execution time, in a system for processing a request for an execution of the machine learning jobs.

Aspects of the present disclosure also provide a system and method that accurately determine the expected execution time of machine learning jobs using new input factors that have not been previously considered.

The technical aspects of the present disclosure are not restricted to those set forth herein, and other unmentioned technical aspects will be clearly understood by one of ordinary skill in the art to which the present disclosure pertains by referencing the detailed description of the present disclosure given below.

According to some embodiments of the present disclosure, there is provided a system for scheduling machine learning jobs. The system includes a user interface provision unit configured to transmit, to a user terminal, data for forming an input interface to receive job information including information indicative of a checkpoint file of a model to be executed and require resource information, a resource management unit configured to manage a job queue including items, wherein each item of the job queue includes the job information and annotation including an expected execution time, complement for an item in which the expected execution time is not recorded in the annotation by receiving the expected execution time from an execution time expectation unit, and execute job scheduling using the job information of each item of the job queue, and the execution time expectation unit configured to calculate memory usage necessary for executing the model with information of the checkpoint file and determine the expected execution time of the model, using the memory usage, wherein the checkpoint file is a file output by a machine learning framework for storing the model to be executed.

According to another embodiments of the present disclosure, there is provided a method for scheduling machine learning jobs performed by a computing device. The method includes receiving job information including information indicative of a checkpoint file of a model to be executed and required resource information, determining an expected execution time of the model using memory usage for executing the model after calculating the memory usage, using information on the checkpoint file, and automatically performing job scheduling for the model, using the expected execution time of the model and the required resource information, wherein the checkpoint file is a file output by a machine learning framework for storing the model to be executed.

According to another embodiments of the present disclosure, there is provided a computer program coupled to a computing device and a computer-readable medium storing the computer program. The computer program includes instructions for receiving job information including information indicative of a checkpoint file of a model and required resource information, wherein the checkpoint file is a file output by a machine learning framework for storing the model to be executed, determining an expected execution time of the model using memory usage after calculating the memory usage necessary for executing the model to be executed using information of the checkpoint file, and automatically performing job scheduling for the model using the expected execution time of the model and the required resource information.

### BRIEF DESCRIPTION OF THE DRAWINGS

The above and other aspects and features of the present disclosure will become more apparent by describing in detail exemplary embodiments thereof with reference to the attached drawings, in which:

FIG. 1 illustrates a configuration of a system for scheduling machine learning jobs according to one embodiment of the present disclosure;

FIGS. 2 and 3 are block diagrams describing in more detail some components of the system for scheduling machine learning jobs described with reference to FIG. 1;

FIG. 4 is a view illustrating an exemplary machine learning information input screen that can be provided by the system for scheduling machine learning jobs described with reference to FIG. 1;

FIGS. 5 to 8 are views describing a process of processing a checkpoint file in some embodiments of the present disclosure;

FIG. 9 is a view describing a method of calculating memory usage when a machine learning model based on a convolution operation is executed in some embodiments of the present disclosure;

FIG. 10 is a view describing a method for determining an expected execution time of machine learning jobs using memory usage in some embodiments of the present disclosure;

FIGS. 11A and 11B are views describing a result of increasing resource utilization as a result of scheduling machine learning jobs according to some embodiments of the present disclosure;

FIG. 12 is a flowchart of a method for scheduling machine learning jobs according to the other embodiments of the present disclosure;

FIG. 13 is a detailed flowchart illustrating some operations of the method for scheduling machine learning jobs described with reference to FIG. 12;

FIG. 14 is a flowchart of a method for scheduling machine learning jobs according to another embodiment of the present disclosure; and

FIG. 15 is a hardware configuration diagram of a computing device that can be used as a component in some embodiments of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings.

The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof

Hereinafter, embodiments of the present disclosure will be described with reference to the attached drawings.

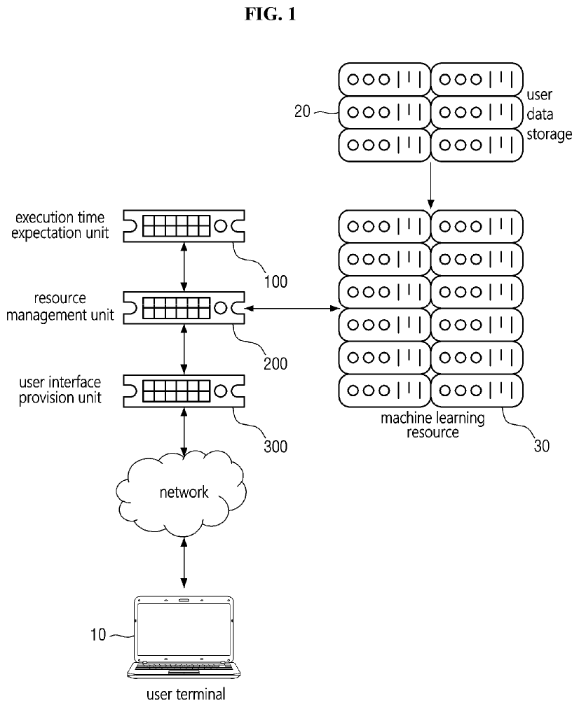

Referring to FIG. 1, a configuration and an operation of a system for scheduling machine learning jobs according to one embodiment of the present disclosure will be described below.

As illustrated in FIG. 1, the system for scheduling machine learning jobs according to the present embodiment may include an execution time expectation unit 100, a resource management unit 200, and a user interface provision unit 300. FIG. 1 illustrates that the execution time expectation unit 100, the resource management unit 200, and the user interface provision unit 300 are computing devices physically separated from each other. In some embodiments, the execution time expectation unit 100, the resource management unit 200, and the user interface provision unit 300 may be implemented as components of one computing device.

A machine learning resource 30 may be understood as a cloud service-based server farm composed of a plurality of physical servers or virtual servers. The machine learning resource 30 may perform a machine learning job under the control of the resource management unit 200.

In addition, the machine learning resource 30 may perform a machine learning job using training data stored in a user data storage 20. The user data storage 20 is accessed by a user terminal 10 to input and output data for machine learning, such as training data. While FIG. 1 illustrates the user data storage 20 and the machine learning resource 30 as systems physically separated from each other, in some embodiments, some of the hardware resources included in the machine learning resource 30 may be allocated to a user volume for storing user data and the user volume may be used as the user data storage 20.

The resource management unit 200 monitors an idle resource of the machine learning resource 30, and processes a request for performing a machine learning job input through the user interface provision unit 300 using the monitoring results. In addition, the resource management unit 200 registers the machine learning job in a job queue, which was requested for execution, then requests and receives an expected execution time of the machine learning job from the execution time expectation unit 100, and, finally, determines when each machine learning job will be performed in the machine learning resource 30 using the expected execution time and the results of monitoring the idle resource of the machine learning resource 30.

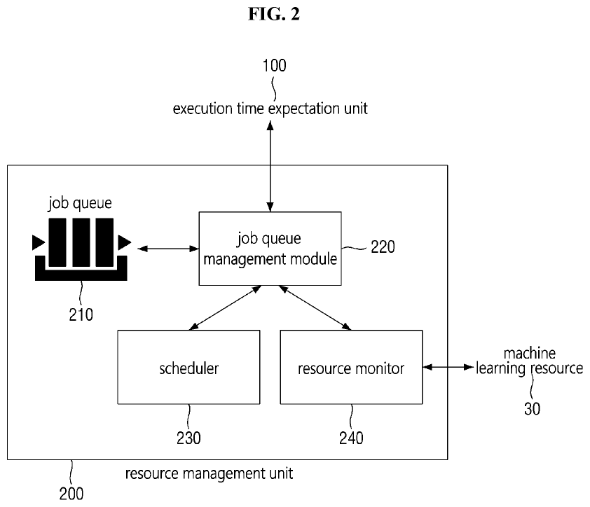

An operation of the resource management unit 200 will be described in more detail with reference to FIG. 2.

A job queue 210 is a data structure operating in a first-in-first-out (FIFO) scheme, and job information on the machine learning job may be stored in each item of the job queue 210.

A job queue management module 220 manages the job queue 210. In other words, the job queue management module 220 receives job information on a new machine learning job input through the user interface provision unit 300, sets the job information indicative of the new machine learning job, and inserts the set job information into the job queue 210. In that case, the job information set by the job queue management module 220 may include information indicative of a checkpoint file of a model to be executed and required resource information, and both the information indicative of the checkpoint file and the required resource information are information input through the user interface provision unit 300.

In addition, the job queue management module 220 may insert the job information and an annotation together into the job queue 210. The annotation is detailed information on the job, and at least some of the information recorded in the annotation may be used to schedule the job. The annotation may include a field indicating an expected execution time. The job queue management module 220 may insert, into the job queue 210, the annotation in which the job information on the new machine learning job and a value of the expected execution time are not recorded.

In addition, the job queue management module 220 may execute a complementary job on a new item in which the expected execution time is not recorded in the annotation among items included in the job queue 210. The complementary job denotes that the expected execution time for the new item is requested and received from the execution time expectation unit 300, and the expected execution time is recorded in the annotation of the new item.

A scheduler 230 receives idle resource information of the machine learning resource 30 from a resource monitor 240 and executes job scheduling using the idle resource information and job information of each item of the job queue 210.

The scheduler 230 may request the job queue management module 220 to execute the complementary job. The scheduler 230 may periodically perform a scheduling process, and may request the job queue management module 220 to perform the complementary job at a start point of the scheduling process.

In other words, the scheduling process may include providing, to the execution time expectation unit, an expected execution time request for the new item in which the expected execution time is not recorded in the annotation among each item of the job queue, receiving the expected execution time from the execution time expectation unit in response to the expected execution time request, and recording the received expected execution time as an expected execution time of an annotation of the new item. The expected execution time for the new machine learning job can be determined immediately before performing the scheduling, thus obtaining the effect capable of determining the expected execution time using the latest updated information.

Meanwhile, in some embodiments, the scheduling using items in which the expected execution time is recorded in the annotation among each item of the job queue is performed first, and then, when there are idle resources, additional scheduling may be performed by further using a new item in which the expected execution time is not recorded in the annotation among each item of the job queue.

In other words, the scheduling process may include allocating resources using the job information of each item, for items in which the expected execution time is recorded in the annotation among each item of the job queue, and, when the idle resources are present even after the allocation of resources, allocating resources using the job information of the new item in which the expected execution time is not recorded in the annotation among each item of the job queue. Furthermore, allocating resources using the job information of the new item may include providing the execution time expectation unit with the expected execution time request for the new item, receiving the expected execution time from the execution time expectation unit in response to the expected execution time request, and recording the received expected execution time as an expected execution time of the annotation. As such, the scheduling using items in which the expected execution time is recorded in the annotation among each item of the job queue can be performed first, thereby obtaining the effect capable of allocating machine learning jobs to the idle resources as soon as possible. In other words, in this case, it is possible to minimize a delay in the allocation of resources even though there are the idle resource, by means of calculation of the expected execution time.

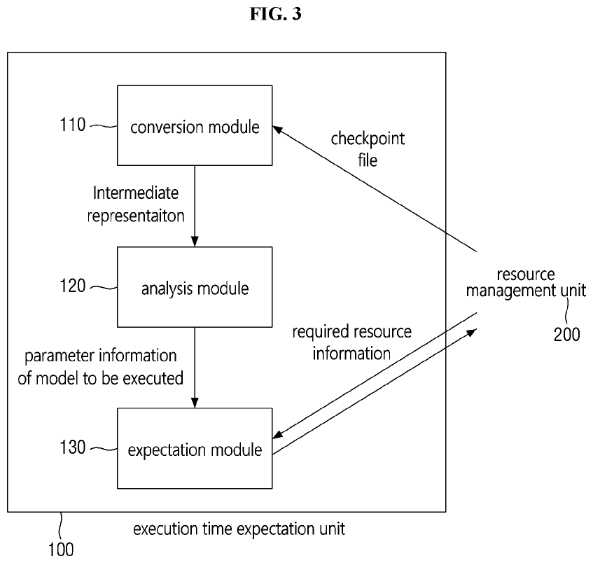

Next, an operation of the execution time expectation unit 100 will be described in more detail with reference to FIG. 3.

The execution time expectation unit 100 receives the job information input through the user interface provision unit 300 from the resource management unit 200. The job information includes the information on the checkpoint file and the required resource information. For example, the information on the checkpoint file may be a path of the checkpoint file on the user data storage. The checkpoint file may be a file output by a machine learning framework for storing the model to be executed. The machine learning framework may be, for example, any one of general-purpose machine learning frameworks such as TensorFlow, PyTorch, scikit-learn, SparkML, Torch, Huggingface, and Keras. The checkpoint file should be understood as a representation indicative of all forms of files generated as a result of exporting the machine learning result of the model by the machine learning framework; in addition, it should not be regarded as a checkpoint file according to the present disclosure because its name is different from that of a checkpoint file.

A conversion module 110 may convert the checkpoint file into an intermediate representation that represents the model to be executed by using the information on the checkpoint file. In addition, an analysis module 120 may analyze the intermediate representation and extract parameter information of the model to be executed.

In addition, an expectation module 130 may obtain memory usage necessary for executing the model to be executed, using parameters of the model to be executed, and determine an expected execution time of the model to be executed using the memory usage.

In some embodiments, the expectation module 130 can determine the expected execution time using the memory usage and the required resource information, thus determining the expected execution time differently according to input resources even when the memory usage is the same.

A more detailed idea of the operation of the execution time expectation unit 100 may be understood with reference to embodiments described below.

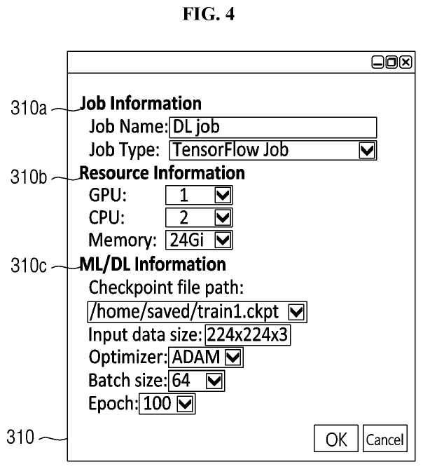

FIG. 4 illustrates an exemplary job information input screen supplied by the user interface provision unit 300. As illustrated in FIG. 4, a job information input screen 310 may include an input area of basic information 310a such as the name and type of the job, an input area of required resource information 310b, and an input area of machine learning information 310c.

The input area of the required resource information 310b is an area where information on hardware resources that have to be allocated to the model to be executed is input. FIG. 4 illustrates that the number of cores of a GPU, the number of cores of a CPU, and the size of a memory may be input. The size of the memory input in the input area of the required resource information 310b is different from the memory usage mentioned throughout the present disclosure. The size of the memory input from the input area of the required resource information 310b refers to the maximum size of the memory that can be used in the machine learning process of the model to be executed, while the memory usage used as an input element for determining the expected execution time refers to the size of a memory necessary for a process of inputting or outputting the model to be executed, calculated using parameter information of the model to be executed.

An input window of path information of the checkpoint file may be included in the input area of the machine learning information 310c. Although FIG. 4 illustrates that the input window of an input data size is included in the input area of the machine learning information 310c, information on the input data size may be extracted from the checkpoint file in some embodiments. In this case, the input window of the data size may not be included in the input area of the machine learning information 310c, or in response to inputting path information of the checkpoint file, the information extracted as a result of analysis of the checkpoint file may be updated and displayed with values of some fields included in the input area of the machine learning information 310c.

In some embodiments, the user interface provision unit 300 may further display information on a scheduling result of a job requested to be executed and the expected execution time. Accordingly, a user who requested to execute the job may confirm that the processing result for his or her request is updated. In addition, if job scheduling is performed periodically, the user interface provision unit 300 may further display the remaining time until the scheduling result of the job requested to be executed is updated.

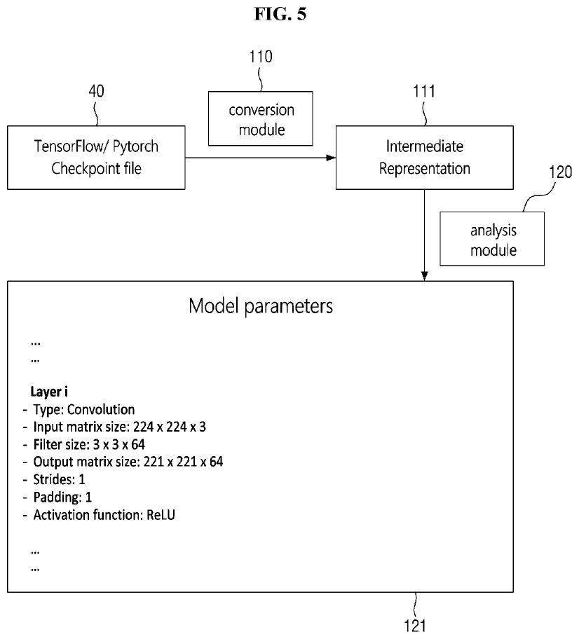

FIG. 5 illustrates a process in which as a result of the operation of the execution time expectation unit 100 described with reference to FIG. 3, the checkpoint file 40 is converted into an intermediate representation 111 by the conversion module 110, and model parameter information 121 is extracted from the intermediate representation 111 by the analysis module 120. The checkpoint file 40 is data in a format dependent on the machine learning framework, while the intermediate representation 111 is data in a format independent of the machine learning framework. Accordingly, the analysis module 120 may be implemented independently of the machine learning framework. Thus, even if the machine learning framework to be supported increases, it is unnecessary to further implement the analysis module 120. Therefore, as illustrated in FIG. 5, the effect capable of easily supporting different kinds of machine learning frameworks is obtained by adopting a system configuration where model parameter information 121 is extracted via the intermediate representation.

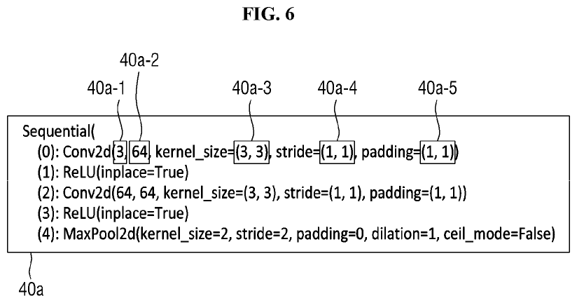

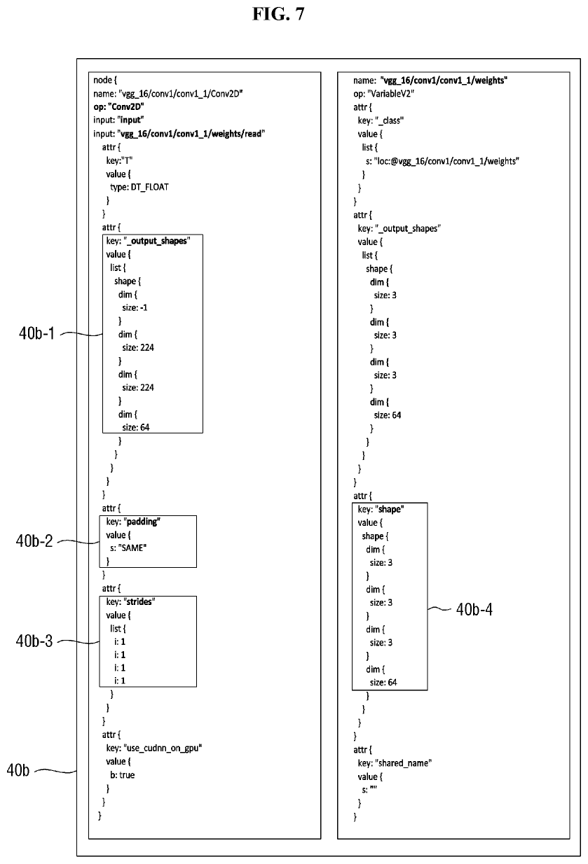

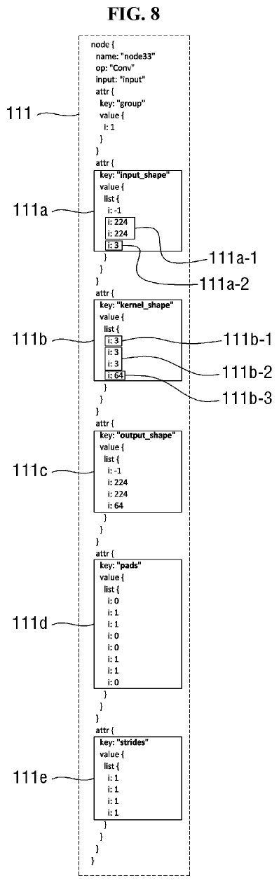

An example in which the checkpoint file 40 is converted into the intermediate representation 111 will be described with reference to FIGS. 6 to 8. FIG. 6 illustrates an exemplary checkpoint file 40a of PyTorch, while FIG. 7 illustrates an exemplary checkpoint file 40b of TensorFlow. The model to be executed, indicated by the checkpoint file of FIG. 6, is substantially the same as the model to be executed, indicated by the checkpoint file of FIG. 7. In other words, both the checkpoint files of both FIG. 6 and FIG. 7 may be converted into the intermediate representation 111 of FIG. 8. However, it can be seen that the format of the checkpoint file greatly varies depending on the machine learning framework.

The format of the intermediate expression 111 may include an arrangement of pairs (of (keys and values). The key may include input data 111a, a kernel 111b, output data 111c, padding 111d, and a stride 111e.

A value of the input data 111a may include a first axis size 111a-1 of the input data, a second axis size 111a-1 of the input data, and the number of input channels 111a-2 of the input data, and a value of the kernel 111b-1 may include the number of input channel 111b-1 of the kernel, a first axis size 111b-2 of the kernel, a second axis size 111b-2 of the kernel, and the number of channels 111b-3 output as a result of a convolution operation.

A process in which each value of the intermediate representation 111 is set will be described below.

First, as a result of analyzing the checkpoint file 40a of the PyTorch, parameters of each layer may be identified. For example, a first layer recorded in the checkpoint file 40a is a convolution layer that performs a 2d convolution operation. As a result of parsing a syntax indicative of the convolution layer, the number of input channels 40a-1 of the kernel, the number of output channels 40a-2 of the kernel, first and second axis sizes 40a-3 of the kernel, a stride 40a-4, and padding 40a-5 are extracted respectively. Since the extracted values correspond to the values for each key of the intermediate expression 111, they will be used to set each value of the intermediate expression 111.

First, the parameters of each layer may be identified with a result of analyzing the checkpoint file 40b of the Tensorflow. The layer recorded in the checkpoint file 40b is also a convolution layer that performs the 2d convolution operation. As a result of parsing the syntax indicative of the convolution layer, data on input data 40b-1, padding 40b-2, a stride 40b-3 and a kernel 40b-4 may be extracted. Since each extracted data includes values corresponding to the values for each key of the intermediate representation 111, they will be used to set each value of the intermediate expression 111.

However, in the case of the padding 40b-2, the value is marked as “SAME”, meaning that the padding is set so that the shapes of input and output data are identical to each other even if the convolution is performed, and accordingly, padding values 111d of the intermediate representation are calculated to be an equation such as (input data size−kernel size+2*padding size)/2+1=output data size=input data size. First to fourth values of the padding values 111d denote padding values in one direction with respect to batch size, x, y, and channel dimensions, respectively. In addition, fifth to sixth values of the padding values 111d refer to padding values in the opposite direction.

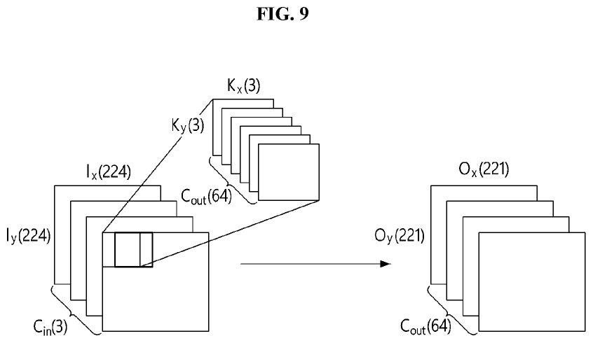

FIG. 9 is a view describing a process in which the expectation module 130 calculates the memory usage used by the model to be executed, using parameter information of the model to be executed.

The meanings of each parameter illustrated in FIG. 9.

Ix=First axis size of input data, Iy=Second axis size of input data, Cin=Number of channels of input data, Kx=First axis size of kernel, Ky=Second axis size of kernel, Cout=Number of channels output as a result of convolution operation, Ox=First axis size of output data, Oy=Second axis size of output data, and precision=Number of bytes per element

The parameters of FIG. 9 may be understood as values extracted from the intermediate representation. In addition, as a value of the precision is a predefined value, it may be, for example, 4 bytes.

In some embodiments, the memory usage used by the model to be executed is calculated by (number of elements of input data, convolution operation data and output data)×(size of each element). That is, this is {(Ix×Iy×Cin)+(Kx×Ky×Cin×Cout)+(Ox×Oy×Cout)}×(precision), and the memory usage according to the example of the intermediate representation illustrated in FIG. 8 will be {(224×224×3)+(3×3×3×64)+(221×221×64)}×(4 bytes)=13,112,320 bytes.

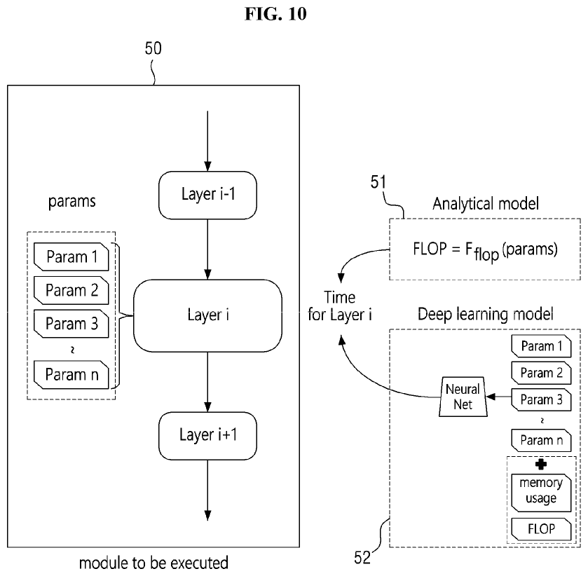

FIG. 10 is a view describing a process where, by means of memory usage used by a model 50 to be executed, the expectation module 130 determines the expected execution time of the model to be executed. Since the model 50 to be executed based on an artificial neural network is configured by sequentially connecting a plurality of layers, the expected execution time can be calculated by adding up the time required for each layer.

The expectation module 130 may calculate the time required for each layer using at least one of an analytical model 51 and a data-driven model 52 such as a deep learning model.

The analytical model refers to an equation for receiving a floating point operation (FLOP) for each layer. In the case of the convolution layer illustrated in FIG. 9, the FLOP thereof will be (total number of elements of output data)×(calculation number for calculating each element). In addition, this will be (Ox×Oy×Cout)×(Kx×Ky×Cin), and, numerically, this will be (221×221×64)×(3×3×3)=84,397,248 flop. In other words, in the case of the convolution layer illustrated in FIG. 9, the time required corresponding to 84,397,248 flops may be calculated.

Meanwhile, the data-driven model 52 may be a deep learning model that is machine-learned to receive an additional feature along with the parameters of each layer and output a required time. The additional feature may include the memory usage. In addition, the additional feature may further include the FLOP. Given that memory usage can be a new input factor that has not been considered in determining the time required for machine learning jobs, and that with improvement of GPU performance, the time required to load training data into a memory can be a major bottleneck, the data-driven model 52 that receives the memory usage as a feature may accurately infer the time required for each layer.

The expectation module 130 may finally determine the time required for the layers by using at least one of the time required for the layer output from the analytical model 51 and the time required for the layer output from the data-driven model 52.

In some embodiments, the expectation module 130 may determine the time required for the layer output from the data-driven model 52 in which the memory usage is input as a feature, as a final time required for the layer.

In some embodiments, the expectation module 130 may finally determine the time required for the layer by weighting and adding up the time required for the layer output from the analytical model 51 and the time required for the layer output from the data-driven model 52, and weights of the analytical model 51 and the data-driven model 52 may be dynamically adjusted based on information on idle resources.

The methods described thus far can more accurately determine the expected execution time of the model to be executed, which enables the scheduling for machine learning jobs to satisfy both fairness and efficiency.

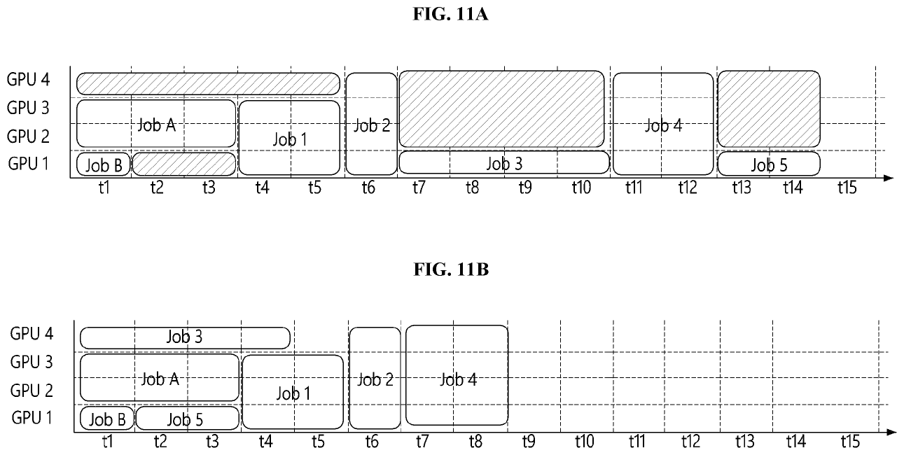

FIG. 11A illustrates a result of conventional machine learning job scheduling according to fairness priority. When job execution is requested in the order of jobs A, B, 1, 2, 3, 4 and 5, FIG. 11A illustrates a result of fairly allocating resources for each machine learning job according to the request order. However, the scheduling result illustrated in FIG. 11A shows low efficiency, because a great deal of idle time occurs in using a GPU.

On the other hand, if the expected execution time of the model to be executed can be accurately determined and trusted, this will enable scheduling that satisfies both fairness and efficiency. FIG. 11B illustrates that job 3 requiring one GPU and job 5 can be given resources faster as each execution time is accurately expected, thereby obtaining efficient scheduling results. The scheduling process will be described in further detail through embodiments described below.

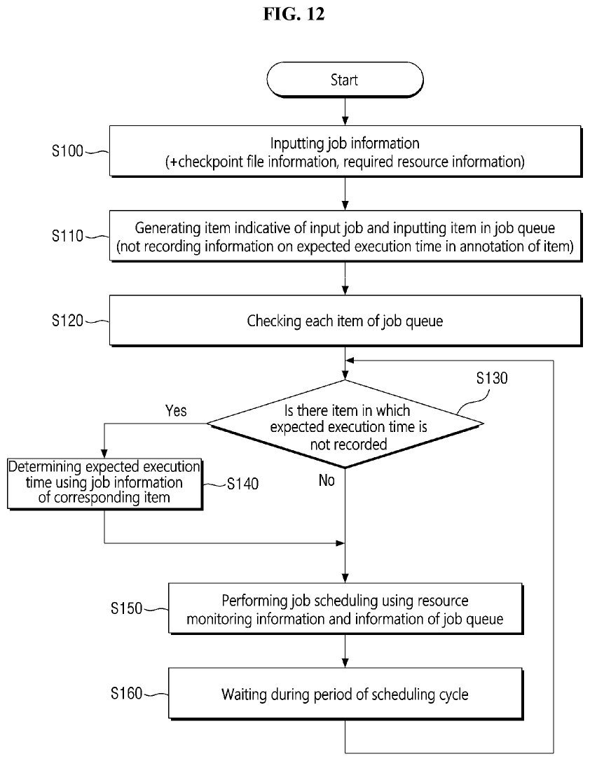

Next, a method for scheduling machine learning jobs according to another embodiment of the present disclosure will be described with reference to FIGS. 12 to 14. The method for scheduling machine learning jobs according to the present embodiment may be performed by one or more computing devices. In other words, in method for scheduling machine learning jobs according to the present embodiment, all operations may be performed by one computing device, or some operations may be performed by another computing device. Hereinafter, when describing the method according to the present embodiment, the description of the subject of performing some operations may be omitted. In that case, the subject of performing the corresponding operation should be understood to be the computing device. The computing device may be, for example, at least one of the execution time expectation unit 100 and the resource management unit 200 in the embodiment described with reference to FIG. 1.

First, this will be described with reference to FIG. 12.

When inputting the job information including the information on the checkpoint file and the required resource (S100), the job information is input to the job queue (S110). At this time, the job information and the annotation are input to the job queue, and the expected execution time included in the annotation is not recorded.

Next, each item input to the job queue is checked (S120). According to the checking results, when there is an item including an annotation in which the expected execution time is not recorded (S130), the expected execution time is determined using the job information of the item according to the aforementioned embodiment (S140).

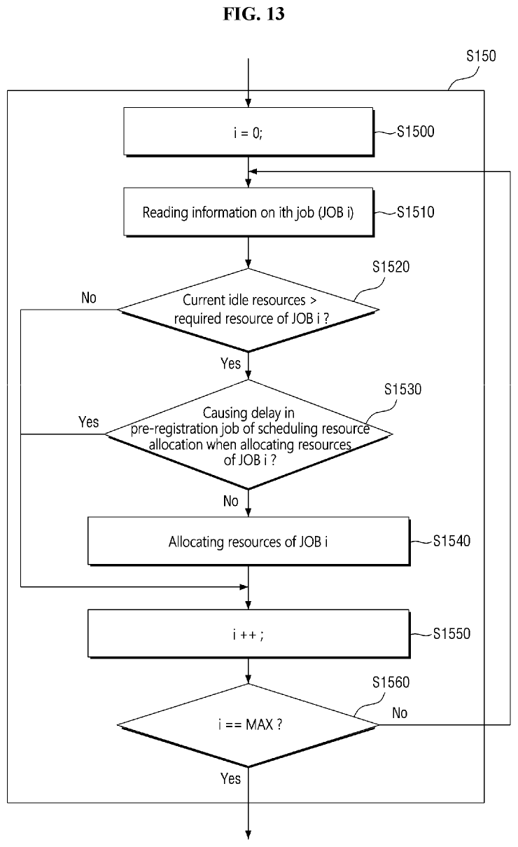

Next, job scheduling is advanced using an idle resource status according to resource monitoring information and the information of the job queue (S150). When the job scheduling during a corresponding period is completed, waiting is continued during the period of a scheduling cycle (S160). The job scheduling takes into account both efficiency and fairness and will be described in more detail with reference to FIG. 13.

Basically, the job scheduling is performed on items to which the resources have not been allocated among all items of the job queue. An index of the job queue is initialized (S1500), and the job information of the current index is retrieved from the job queue (S1510).

It is determined whether the amount of current idle resources according to the resource monitoring information exceeds the amount of required resources according to the job information of the current index (S1520). For example, when the current idle resources are two cores of the GPU and the required resources according to the job information of the current index are one core of the GPU, it will be determined that the amount of current idle resources exceeds the amount of required resources according to the job information of the current index.

However, just because the amount of current idle resources exceeds the amount of required resource according to the job information of the current index, the resources are not unconditionally allocated for machine learning jobs according to the job information of the current index. This is because resource allocation may cause a delay in scheduled pre-registration jobs. Therefore, the expected execution time should be accurately predicted. In order to accurately determine whether or not the resource allocation causes the delay in the scheduled pre-registration jobs, the expected execution time has to be accurately predicted.

Accordingly, even if the amount of current idle resources exceeds the amount of required resources according to the job information of the current index, the resources are allocated (S1540) only when the resource allocation does not cause the delay in the scheduled pre-registration jobs at the time of allocating the resources to the job of the current index (S1530).

Next, a next index of the job queue will be sequentially processed (S1550) and, when the processing of all items of the job queue is completed, the scheduling of the corresponding period will be completed (S1560).

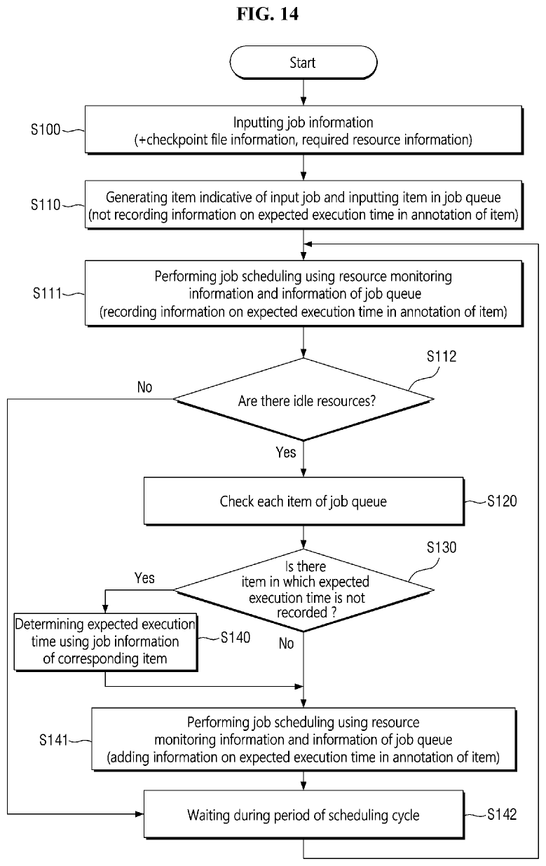

Meanwhile, in some embodiments, as illustrated in FIG. 14, when there is an idle resource (S112) even after preceding the job scheduling using the information on the expected execution time recorded in the annotation of the item among the items of the job queue (S100, S110 and S111), additional scheduling may be performed using new items that do not contain the information on the expected execution time in the annotation of the item among the items of the job queue. When there are no idle resources even after preceding the job scheduling using the information on the expected execution time recorded in the annotation of the item among the items of the job queue (S100, S110 and S111), waiting is continued during the period of a scheduling cycle (S142), and then the scheduling job of the next period will be advanced.

In other words, in that case, when there are the idle resources, each item of the job queue is checked (S120), and a complementary action for recording the expected execution time is performed (S140) on an item in which the expected execution time is not recorded (S130), and additional scheduling may be performed using new items in which the information on the expected execution time is not recorded in the annotation the item among the items of the jog queue (S141). When the scheduling is completed in this way, the waiting may be continued during the period of a scheduling cycle (S142).

As such, the scheduling can be performed first using the items in which the expected execution time is recorded in the annotation among each of the items of the job queue, thus obtaining the effect capable of allocating the idle resources to the machine learning jobs as soon as possible. In other words, in that case, it is possible to minimize a delay in the resource allocation even though there are the idle resources, by means of the calculation of the expected execution time.

The technical idea of the present disclosure described with reference to FIGS. 1 to 14 may be implemented with a computer-readable code on a computer-readable medium. The computer-readable recording medium may be, for example, a mobile recording medium (e.g., USB storage device, a portable hard disk, etc.). The computer program recorded on the computer-readable recording medium can be transmitted to another computing device over a network such as the Internet and be installed in another computing device; accordingly, the computer program can be used in the other computing device.

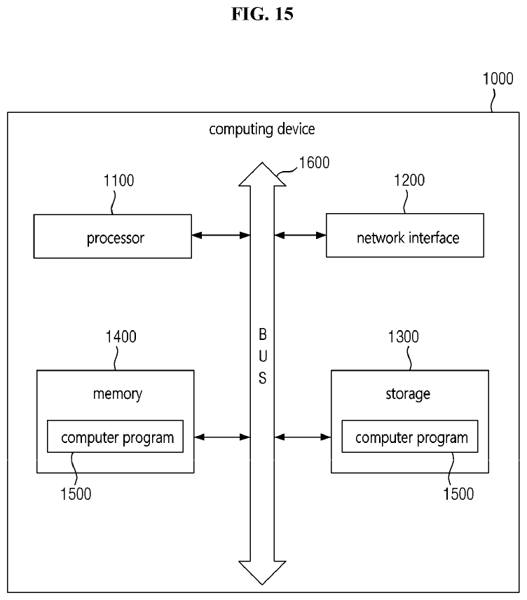

Hereinafter, a hardware configuration of an exemplary computing device according to some embodiments of the present disclosure will be described with reference to FIG. 15. The computing device may be, for example, the execution time expectation unit 100, the resource management unit 200, or the user interface provision unit 300 described with reference to FIG. 1.

FIG. 15 is an exemplary diagram of a hardware configuration capable of implementing the computing device according to various embodiments of the present disclosure. A computing device 1000 according to the present embodiment may include a processor 1100, a system bus 1600, a network interface 1200, a memory 1400 configured to load a computer program 1500 performed by the processor 1100, and a storage 1300 configured to store the computer program 1500. FIG. 9 illustrates only components related to embodiments of the present disclosure. Therefore, it may be known by one of ordinary skill in the art to which the present disclosure pertains that other universal components may be further included along with the components illustrated in FIG. 15.

The processor 1100 controls the overall operations of each component of a computing device 2000. The processor 1100 may be understood as a central processing unit (CPU). Furthermore, the processor 1100 may perform an arithmetic operation on at least one application or program for performing method/operations according to various embodiments of the present disclosure.

The memory 1400 stores different types of data, instructions, and/or information. The memory 1400 may load one or more programs 1500 from the storage 1300 in order to perform the methods/operations according to various embodiments of the present disclosure. An example of the memory 1400 may be a random access memory (RAM), but the present disclosure is not limited thereto.

The system bus 1600 provides a communication function between components of the computing device 1000. The system bus 1600 may be implemented as various types of buses such as an address bus, a data bus, and a control bus. The network interface 1200 supports wired/wireless Internet communication of the computing device 1000.

The storage 1300 may non-temporarily store one or more computer programs 1500. The storage 1300 may include a nonvolatile memory such as a flash memory, a hard disk, a removable disk, or any type of computer-readable recording medium well known in the technical field to which the present disclosure belongs.

The computer program 1500 may include one or more instructions implementing the methods/operations according to various embodiments of the present disclosure. When the computer program 1500 is loaded into the memory 1400, the processor 1100 may execute the one or more instructions to perform methods according to various embodiments of the present disclosure.

The computer program 1500 may include an instruction of transmitting, to the user terminal, data for forming an input interface to receive the job information including information indicative of the checkpoint file of the model to be executed and the required resource information, an instruction of managing the job queue, wherein each item of the job queue includes the job information and the annotation, and the annotation includes the expected execution time, an instruction of complementing for items in which the expected execution time is not recorded in the annotation by receiving the expected execution time from the execution time expectation unit, and performing the job scheduling using the job information of each item of the job queue, and an instruction of calculating the memory usage necessary for executing the model to be executed, using the information on the checkpoint file, and determining the expected execution time of the model to be executed by using the memory usage.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A system for scheduling machine learning jobs, the system comprising:
one or more processors; and
a memory storing one or more programs,
wherein the one or more programs are configured to be executed by the one or more processors, and the one or more programs include instructions for:
a user interface provision unit configured to transmit, to a user terminal, data for forming an input interface to receive job information comprising information indicative of a checkpoint file of a model to be executed and require resource information, wherein the checkpoint file of the model is a file output by a machine learning framework for storing the model;
a resource management unit configured to:
manage a job queue including items, wherein each item of the job queue comprises the job information and annotation including an expected execution time;
complement for an item in which the expected execution time is not recorded in the annotation by receiving the expected execution time from an execution time expectation unit; and
execute job scheduling using the job information of each item of the job queue; and
the execution time expectation unit configured to calculate memory usage necessary for executing the model with information of the checkpoint file and determine the expected execution time of the model, using the memory usage.

2. The system of claim 1, wherein the resource management unit is configured to perform a scheduling process periodically,
wherein the scheduling process comprises:
providing the execution estimate expectation unit with an execution estimate time request for a new item in which the expected execution time is not recorded in the annotation among each item of the job queue;
receiving the expected execution time from the execution time expectation unit in response to the execution estimate time request; and
recording the received expected execution time as the expected execution time of the annotation of the new item.

3. The system of claim 1, wherein the resource management unit is configured to perform a scheduling process periodically,
wherein the scheduling process comprises:
allocating resources for, among the items of the job queue, items in which the expected execution time is recorded in the annotation; and
when there are idle resources even after allocating the resources, allocating resources using the job information of a new item in which the expected execution time is not recorded in the annotation, among the items of the job queue,
wherein the allocating resources using the job information of the new item comprises:
providing the execution estimate expectation unit with an execution estimate time request for the new item, receiving the expected execution time from the execution time expectation unit in response to the execution estimate time request; and
recording the received expected execution time as the expected execution time of the annotation of the new item.

4. The system of claim 1, wherein the resource management unit is configured to periodically perform a scheduling process on the job queue including a first item and a second item inserted after inserting the first item,
wherein the scheduling process comprises:
when an amount of idle resources of a corresponding period exceeds an amount of required resources in a required resource information of the second item, allocating resources for the second item, using the idle resources only when there is no delay in the first item according to an execution of the second item,
wherein the first item is that the allocation of resources is scheduled later than the corresponding period.

5. The system of claim 1, wherein the execution time expectation unit comprises:
a conversion module configured to convert the checkpoint file into an intermediate representation;
an analysis module configured to extract parameters of the model by analyzing the intermediate representation; and
an expectation module configured to obtain the memory usage necessary for executing the model, using the parameters of the model, and determine the expected execution time of the model, using the memory usage and the required resource information.

6. The system of claim 5, wherein the intermediate representation is data in a format independent of the machine learning framework, and the format includes a plurality of pairs of a key and a value.

7. The system of claim 6, wherein the model includes a convolution operation;
the key of the format includes input data, a kernel, output data, padding, and a stride;
a value of the input data comprises a first axis size of the input data, a second axis size of the input data, and the number of input channels of the input data; and
a value of the kernel comprises a first axis size of the kernel, a second axis size of the kernel, and the number of channels output as a result of the convolution operation.

8. The system of claim 7, wherein the expectation module is configured to calculate the memory usage of the model using the following equation:
{(Ix×Iy×Cin)+(Kx×Ky×Cin×Cout)+(Ox×Oy×Cout)}×(precision)
where,
Ix=the first axis size of the input data,
Iy=the second axis size of the input data,
Cin=the number of channels in the input data
Kx=the first axis size of the kernel,
Ky=the second axis size of the kernel,
Cout=the number of channels output as a result of the convolution operation,
Ox=the first axis size of the output data,
Oy=the second axis size of the output data, and
precision=bytes per element.

9. The system of claim 5, wherein the expectation module is configured to:
obtain expected execution times for each layer of the model by inputting parameters of each layer of the model and the memory usage into a deep learning model that outputs the expected execution times for each layer of the model; and
add up the obtained expected execution times and determine the expected execution time of the model.

10. The system of claim 1, wherein the user interface provision unit is configured to:
further transmit information on a scheduling result of a job requested for execution and the expected execution time to the user terminal.

11. A method for scheduling machine learning jobs, the method performed by a computing device comprising a hardware processor, the method comprising:
receiving job information including information indicative of a checkpoint file of a model to be executed and required resource information, wherein the checkpoint file is a file output by a machine learning framework for storing the model;
determining an expected execution time of the model using memory usage for executing the model after calculating the memory usage, using information on the checkpoint file; and
automatically performing job scheduling for the model, using the expected execution time of the model and the required resource information.

12. The method for scheduling machine learning jobs of claim 11, wherein the determining of the expected execution time of the model comprises:
converting the checkpoint file into an intermediate representation;
extracting parameters of the model by analyzing the intermediate representation;
determining the expected execution time of the model using the memory usage and the required resource information after calculating the memory usage using the parameters of the model.

13. The method for scheduling machine learning jobs of claim 12, wherein the intermediate representation is data in a format independent of the machine learning framework, and the format includes a plurality of pairs of a key and a value.

14. The method for scheduling machine learning jobs of claim 13, wherein the model includes a convolution operation,
the key of the format includes input data, a kernel, output data, padding, and a stride;
a value of the input data comprises a first axis size of the input data, a second axis size of the input data, and the number of input channels of the input data; and
a value of the kernel comprises a first axis size of the kernel, a second axis size of the kernel, and the number of channels output as a result of the convolution operation.

15. The method for scheduling machine learning jobs of claim 14, wherein the calculating of the memory usage comprises:
calculating the memory usage of the model using the following equation:
{(Ix×Iy×Cin)+(Kx×Ky×Cin×Cout)+(Ox×Oy×Cout)}×(precision)
where,
Ix=the first axis size of the input data,
Iy=the second axis size of the input data,
Cin=the number of channels in the input data
Kx=the first axis size of the kernel,
Ky=the second axis size of the kernel,
Cout=the number of channels output as a result of the convolution operation,
Ox=the first axis size of the output data,
Oy=the second axis size of the output data, and
precision=bytes per element.

16. A computer program coupled to a computing device comprising a processor and a computer-readable medium storing the computer program, the computer program includes instructions for:
receiving job information including information indicative of a checkpoint file of a model to be executed and required resource information, wherein the checkpoint file is a file output by a machine learning framework for storing the model;
determining an expected execution time of the model to be executed using memory usage after calculating the memory usage necessary for executing the model using information of the checkpoint file; and
automatically performing job scheduling for the model using the expected execution time of the model and the required resource information.
